(19) United States
(12) Patent Application Publication
(10) Pub. No.: US 2003/0110100 A1
(43) Pub. Date: Jun. 12, 2003

(54) Method and system for displaying product information in catalogs accessed via the Internet

(76) Inventor: John Wirth JR., Dubois, WY (US)

Correspondence Address: NIXON & VANDERHYE, PC, 1100 N GLEBE ROAD, 8TH FLOOR, ARLINGTON, VA, 22201-4714, US

(21) Appl. No.: 10/274,370

(22) Filed: Oct. 21, 2002

Related U.S. Application Data
(63) Continuation-in-part of application No. 10/004,107, filed on Dec. 6, 2001.

(51) Int. Cl. G06F 17/60

(52) U.S. Cl. 705/27

(57) ABSTRACT

A method and system for browsing and ordering from product catalogs via the Internet is disclosed. When a customer requests a catalog page, a low resolution image of the requested page is first provided to the customer. The size of the computer file corresponding to the page is reduced to be as small as possible, while still allowing products imaged on the page to be recognized. When a customer clicks on a hyperlink in the form of a blocked area in the low resolution image catalog page corresponding to a particular product, a more detailed presentation for that product is built from stored files which include a high resolution picture of the product, a headline file identifying the product, a copy file describing the product, an order block data file providing detailed information for ordering the product, and a product data base containing product specifications. The product specifications can pertain to any aspect of a product, such as, for example, a product's size, shape, weight, color, materials, etc.. By initially providing low resolution images for requested catalog pages, such pages can be quickly downloaded to a customer's computer.

### FIELD OF THE INVENTION

The present invention relates to a method and system for displaying product information in product catalogs accessed via an Internet webpage.

### BACKGROUND OF THE INVENTION

Historically, people have shopped from the comfort of their homes (or offices) using printed paper catalogs. The traditional printed catalog typically is a multi-page book containing an array of product pictures and descriptions and detailed information for purchasing such products.

A typical printed catalog page may include a title, which is the category of products presented on the page, and one or more presentations for products appearing within the category name. Typically, each presentation includes a picture of the product, a headline defining the benefits of the product, copy beneath the headline describing various features of the product, including, for example, size, color weight and dimensions, and detailed information and pricing for ordering the product from the catalog company.

Also included in a typical printed catalog is an order form for purchasing selected products using the ordering information. The ordering information for desired products is placed on the order form, which is then mailed to the catalog company. Alternatively, a purchaser can call what is typically a toll-free number to speak to a catalog company representative who takes the information for processing product purchases.

More recently, the Internet has become a vehicle for electronic commerce and a viable alternative for in home (or office) purchases of products from companies that maintain a web site from which product information may be obtained and products ordered.

The Internet is a global communications system in which a vast number of computers and other devices are networked to allow user-to-user communications and transfers of data files from one machine to any other on the network. The World Wide Web serves as one type of interface to the Internet that allows users to readily navigate the Internet's vast resources. The Web allows information and data dispersed across the Internet to be linked in an easily accessible way. This information or data typically includes text, graphics, illustrations, sound and video.

The World Wide Web uses a client/server architecture in which client programs, called web browsers, running on users' computers request data from server programs running on other computers known as servers, which are located elsewhere on the Internet. The data requested by a user's browser is typically part of a web site maintained by a company or other entity. When the browser program requests the data, a web server hosting the web site sends the requested data back over the Internet to the browser, which then interprets and displays the data on the user's computer screen. Thus, a web browser is a computer program or application that has the ability to request data from any server on the Internet and interpret and display on a user's computer the data sent by a server through the Internet. Conversely, a web server is a computer program that responds to web browser requests for data and sends the requested data to the web browser through the Internet.

A web page is typically a file that contains HTML (hypertext mark-up language) files containing text and graphics, along with a set of HTML tags that describe how the text and graphics should be formatted and displayed on a user's computer screen. The tags are instructions that tell the web browser how the page should look when it displays the page on a user's computer. So, for example, the tags serve to change the font size or color, arrange things in columns, etc. The graphics or images on web pages are typically either GIF files or JPG files. The GIF files are generally used for drawn graphics, while the JPG files are generally used for photographs or scanned images.

The World Wide Web uses an addressing system known as a Uniform Resource Locator (URL). A URL consists of four parts that, when combined, completely define the location of any file or service located anywhere on the Internet. These parts are the protocol, domain name, path, and filename. Thus, a user's browser, in requesting a web page from a web site, sends a message over the Internet that includes at least a transfer protocol (e.g., http://), and a domain name (e.g., www.catalogcompanyname.com). The last two components of a URL may or may not exist, depending on the location and type of information any given hyperlink points to. The server receives the user's request and retrieves the requested web page or other file, which is composed in HTML. The server then transmits the requested page or other file back across the Internet to the user's computer. The user's browser program receives the HTML file and displays its interpretation of the requested file. Thus, browser programs send requests and receive the data needed to display the HTML page on a user's screen. This includes the HTML file itself, plus each of the graphic, sound and video files mentioned in the HTML file. Once the data is retrieved, the browser formats the data as indicated by the HTML tags and displays it on the user's computer screen.

Web pages are typically hypertext documents, i.e., documents which provide clearly visible links to other documents or web pages on the World Wide Web. When a user clicks on a hypertext link, or hyperlink, a new request to retrieve another file is sent over the Internet. With a web browser, a user typically sees formatted documents that contain text, graphics and highlighted hyperlinks. The browsers let a user navigate the Internet, not by entering commands, but rather by moving a mouse pointer to a desired hyperlink and clicking. The browser establishes contact with the related server in a remote computer, and the server transfers the requested file to the user's machine, displaying it in the user's browser as another formatted, hyperlink document. Thus, a user can “surf” the web by hopping from hyperlink to hyperlink without delving deeply into the contents of any particular document.

Users connect to the Internet typically via a modem dial-up connection to an Internet Service Provider, although some connect via a direct line such as a T1 or a T3 line. Most modem dial-up connections occur over regular phone lines. These analog lines have limited bandwidth, which limits the rate of speed at which data can be transferred from the Internet to a user's computer. Common transfer rates for modems used with analog phone lines are 28.8 and 56 Kbps. With a rate of data transfer of 28.8 Kbps, the download of a typical window screen consisting of 50 KBytes of data can take as much as 13 seconds, while a 1 MegaByte image file at the same data transfer speed could take as much as 5 minutes. Thus, where you have a user who is looking to download catalog web pages containing multiple graphical images per page, a significant amount of time can be spent by the user waiting for the download of each page.

It is possible to reduce download time by subscribing to an improved connection service, such as ISDN (Integrated Services Digital Network) or DSL (Digital Subscriber Line), or through a cable modem connected to a cable service. While such services allow for faster download times, they are not available in many locations, such as the rural locations where persons who traditionally use catalogs to shop live. Moreover, there is an additional expense to a user of these services, which may not be affordable or justified, given the purpose for which a user's computer and Internet connection may be used. This may be particularly the case where a user operates his or her computer and Internet connection for personal purposes only.

### SUMMARY OF THE INVENTION

The present invention relates to browsing and ordering from catalogs via the Internet, and, in particular, to a method and system for displaying detailed product information in a manner that also overcomes the download limitations associated with using a typical modem dial-up connection to the Internet. According to the present invention, an Internet user/catalog customer seeking to obtain product information while browsing a catalog, is first provided with a low resolution image file of a requested catalog page that provides the customer with a collection of low resolution images for identifying the products presented on the catalog page. Nominally, this low resolution file would be 20-30 K bytes in size, it having been generated using a reduction computation based on a reduction ratio of nominally 2 MB to 20 KB. Each time the customer requests a new catalog page, a low resolution image of the requested page is displayed on the customer's computer by the customer's browser program. The size of the computer file corresponding to each of the low resolution image pages is reduced to be as small as possible, while still allowing sufficient detail to allow a customer to recognize generally the category name, headline and the products imaged on the page. By initially providing such low resolution images of the requested catalog pages, the pages can be quickly downloaded to a customer's computer, thereby allowing the customer to quickly browse selected catalog “pages.” While product catalogs are typically directed to physical items offered for sale by a catalog company, the present invention also contemplates a broader definition of “products” that may include, for example, services or non-tangible items that may be offered by a company as its products.

When a customer sees a product in which he or she is interested, the customer can request more detailed information about the particular product by clicking on a hyperlink that connects the customer to another file containing such detailed information. The hyperlink, which is embedded in the low resolution image catalog page, may be a blocked area which, in effect, corresponds to the entire presentation of the product pictured on the page. When a customer clicks anywhere in this “live” blocked area corresponding to a particular product, a more detailed presentation for that product is provided. This more detailed presentation may be built from several files which include a higher resolution image (i.e., larger file size) of the product, a headline file identifying the product, a copy file describing the product, an order block data file providing detailed information for ordering the product, and product specifications. The product specifications can pertain to any aspect of a product, such as, for example, a product's size, shape, weight, color, materials, dimensions, etc. The product specifications are added to a data field that is preferably presented in the form of an “elastic” table which can be enlarged or reduced to display as much or as little about a product that is likely to be of interest to the buying public. Thus, by way of example, such product specifications could include basic product dimensions, such as the product's length, width and height, or additional dimensions, such as an angle, radius or diameter of particular parts or features of a product. The existence of detailed specifications for a particular product can be evidenced by using a color or other marking scheme with the product that denotes the existence of the specifications. Thus, drawing of a product can have some aspect that is depicted with a color such as red or yellow that denotes the existence of the product specifications in the detailed product presentation.

The more detailed product presentation is transmitted by the catalog web page server to the customer over the Internet, after which the customer's browser receives the detailed presentation file and displays it in the customer's computer according to the format contained in the more detailed file. If the customer decides to buy the product, another hyperlink in the detailed presentation is then clicked to obtain another file in which information for ordering the product is stored. If the customer chooses to not buy the product, then he or she has the option of returning to the low resolution image catalog page previously being viewed, after which the detailed presentation for another product pictured on that low resolution image catalog page can be requested by clicking on the blocked area link for that product. Alternatively, the customer can request a different catalog page, whereupon a low resolution image of the requested page is then transmitted by the catalog web page server to the customer's browser program for viewing by the customer.

### BRIEF DESCRIPTION OF THE DRAWINGS

FIG. 1 is a block diagram of a system for carrying out the product information displaying method of the present invention;

FIG. 2 is a flow diagram of a catalog browsing and ordering method that can be used in connection with the product information displaying method of the present invention;

FIG. 3 is a sample of a web page for a product catalog company;

FIG. 4 is another page linked to the web page of FIG. 3 through which a customer requests a desired product catalog and particular pages of the product catalog;

FIG. 5 is a sample of a low resolution image catalog page requested using the requesting page of FIG. 4;

FIG. 6 is a detailed presentation of a selected one of the products shown on the low resolution image catalog page of FIG. 5;

FIG. 7 is a second detailed presentation of another product shown on the low resolution image of the catalog page of FIG. 5;

FIG. 8 is a sample of a second low resolution image catalog page requested using the requesting page of FIG. 4;

FIG. 9 is a detailed presentation of a selected one of the products shown on the low resolution image catalog page of FIG. 8 including a product specification table;

FIG. 10 is a sample of a third low resolution image catalog page requested using the requesting page of FIG. 4; and

FIG. 11 is a detailed presentation of a selected one of the products shown on the low resolution image catalog page of FIG. 10 including another product specification table.

### DESCRIPTION OF THE PREFERRED EMBODIMENT

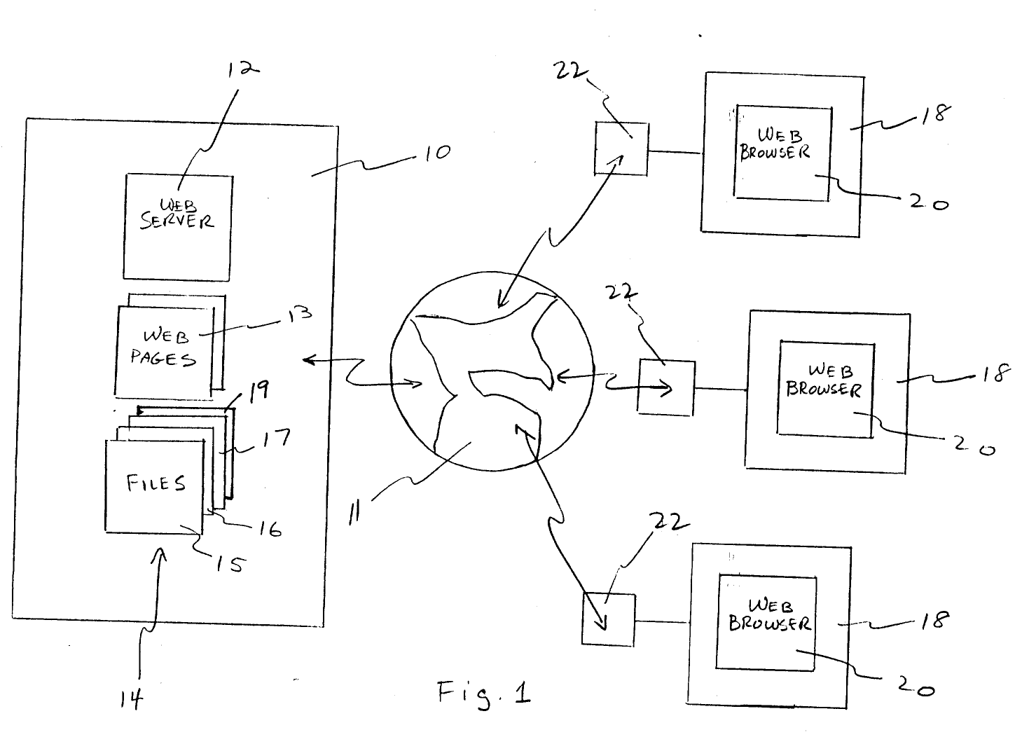

FIG. 1 is a block diagram illustrating a system for carrying out the product information displaying method of the present invention. Shown in FIG. 1 is a server computer system 10 connected to the Internet 11. Stored in the memory (not shown) of computer 10 is a web server program 12 and a product data base including plurality of files 14 relating to a product catalog web page 13. Constituting the plurality of files 14 are a first series of files 15, which are low resolution images of the catalog pages comprising the product catalog, a second, larger series of files 16 which are detailed presentations of the products shown on the low resolution image catalog pages 15, a third series of files 17 displayed to customers as “access pages” to implement the displaying of catalog pages and the ordering of products pictured on such pages, and a fourth series of files 19 containing product specifications.

Also shown in FIG. 1 are several customer systems 18, each of which can be, for example, a television with Internet access, but which is preferably a personal computer with a modem 22 for connecting to the Internet 11. Stored in each computer 18's memory (not shown) is a browser program 20 for requesting information from web servers, such as server 12. The customer systems 18 are each typically operated by a customer desiring to browse, and perhaps order products from, a catalog web page.

Although not specifically shown in FIG. 1, computers 10 and 18 would typically include central processing units (CPUs) and system buses that would couple various computer components to the CPUs. These system buses may be any of several types of bus structures, including a memory bus or memory controller, a peripheral bus, and a local bus using any of a variety of bus architectures. The memory used by computers 10 and 18 would also typically include random access memory (RAM) and one or more hard disk drives that read from, and write to, (typically fixed) magnetic hard disks. A basic input/output system (BIOS), containing the basic routines that help to transfer information between elements within a personal computer system, such as during start-up, may also be stored in read only memory (ROM). Computers 10 and 18 might also include other types of drives for accessing other computer-readable media, such as a removable “floppy” disks, or an optical disk, such as a CD ROM. The hard disk, floppy disk, and optical disk drives are typically connected to a system bus by a hard disk drive interface, a floppy disk drive interface, and an optical drive interface, respectively. The drives and their associated computer-readable media provide nonvolatile storage of computer-readable instructions, data structures, program modules, and other data used by machines, such as computers 10 and 18. Computer 10 will also include a communications device (not shown) for connecting to Internet 11. Such communications device and modems 22 may be internal or external, and are typically connected to the computer's system bus via a serial port interface. Computers 10 and 18 may also include other typical peripheral devices, such as printers, displays and keyboards. Typically, computer 18 would include a display monitor (not shown) on which various catalog pages and other catalog information are displayed.

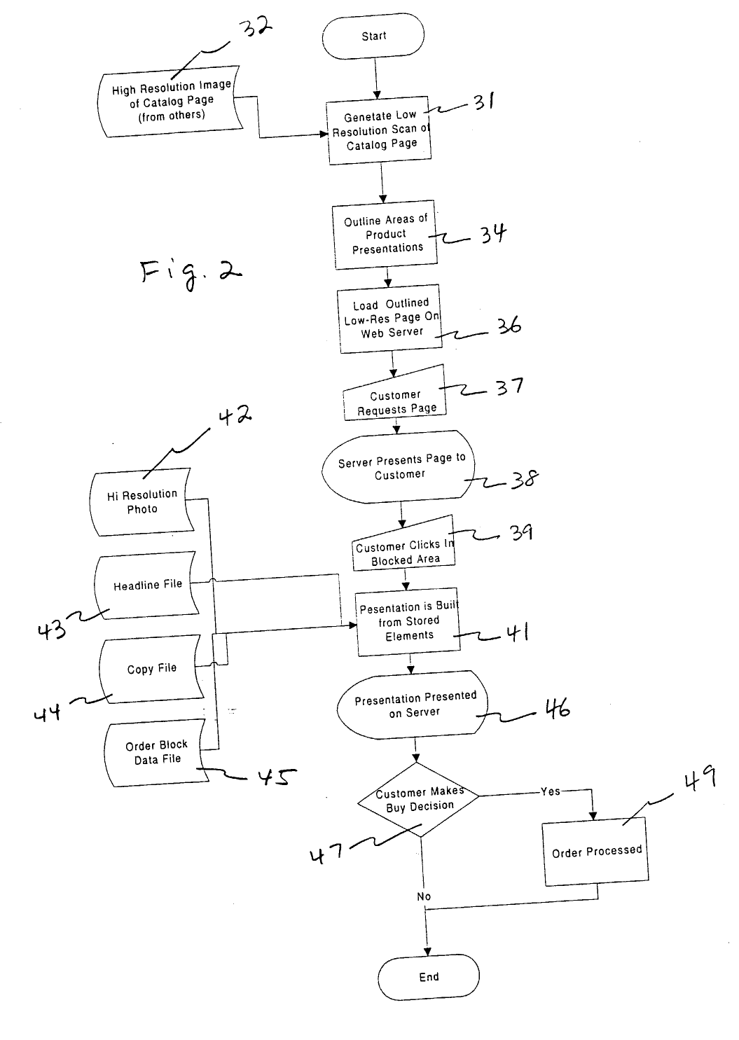

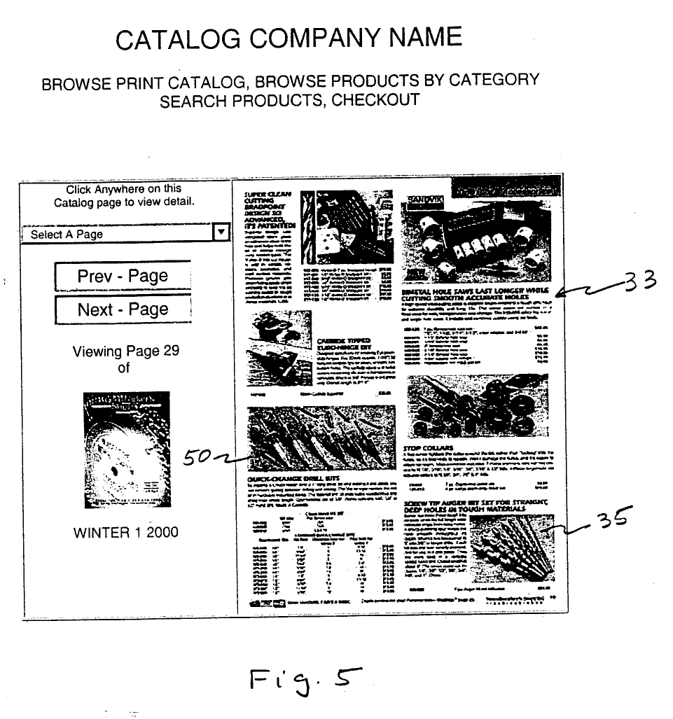

FIG. 2 is a flow diagram of a catalog browsing and ordering method that can be used with the product information displaying method of the present invention. The first step 31 is generating the computer files 15 containing for each catalog page a low resolution scan image from a corresponding detailed catalog page 32. In the present invention, each such low resolution image catalog page is a computer file nominally 20-30K bytes in size. An example of such a low resolution image catalog page 33 is shown in FIG. 5 of the application.

The next step 34 in the method of the present invention is to create for each low resolution image catalog page an image map for each product pictured in the low resolution image catalog page. These image maps use an X-Y coordinate system to define the outline of areas corresponding to the product pictures. Clicking with a mouse within an area, such as area 35 shown in FIG. 5, causes server 13 to return a detailed product presentation page hyperlinked to such area.

A low resolution image is generated for each page of the catalog to be accessed at the product catalog web site. Once the low resolution images of the various catalog pages are generated, the next step 36 shown in FIG. 2 is to load the area outlined low resolution pages 15 into Computer 10's memory so that they can be accessed by web server 12.

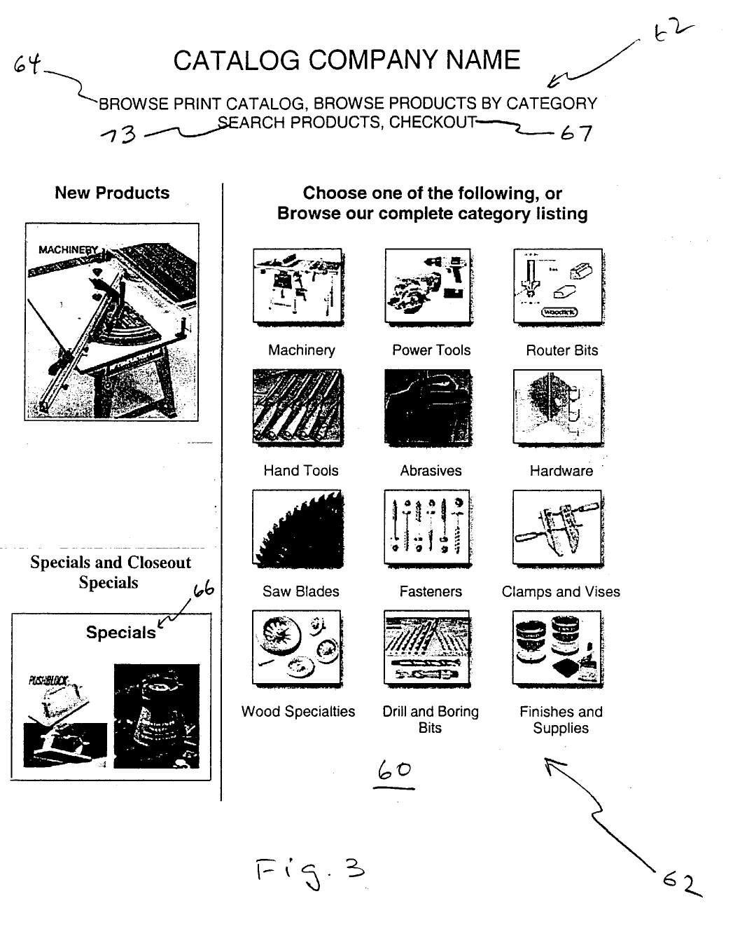

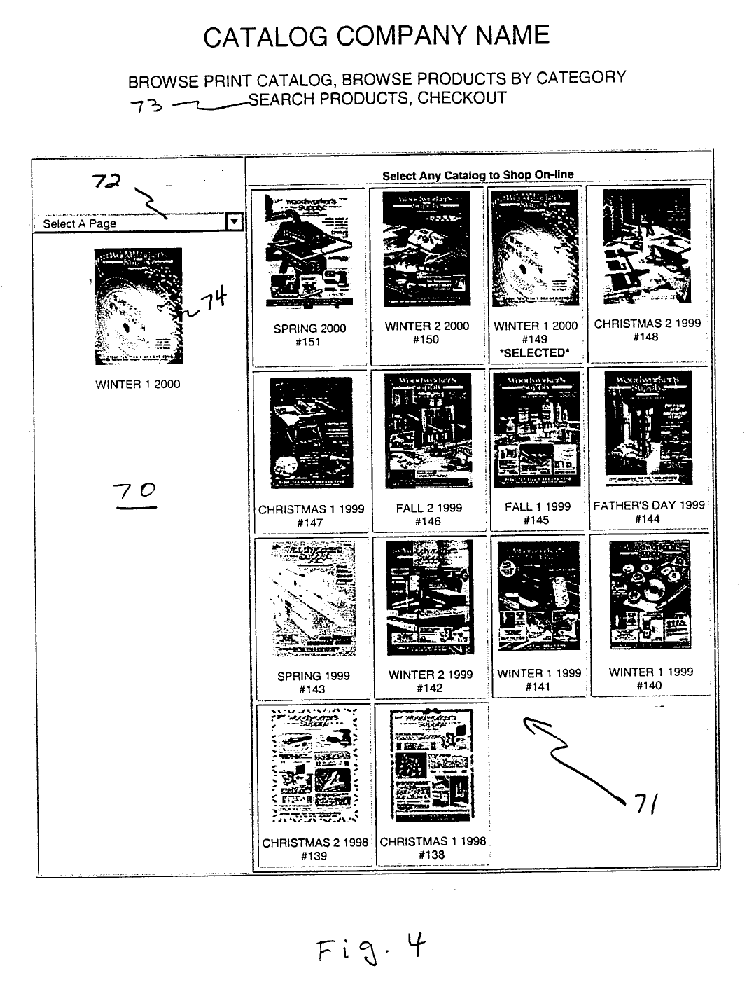

When a customer links to a product catalog web page, such as that shown in FIG. 3, he or she is presented with a display 60, that includes a number of hyperlinks 62 that allow the customer to further link to various files associated with browsing the catalog's pages and with ordering products from the catalog. Clicking on the “browse print catalog” link 64 causes the user to link to a new page 70 shown in FIG. 4 for requesting a particular catalog and then particular pages from the selected catalog. Page 70 shown in FIG. 4 includes a plurality of links 71 for selecting a particular catalog and a page selection field 72 for selecting a desired page number of a selected catalog 74. After the “Select A Page” field 72 is clicked, a drop menu (not shown) appears from which the customer can choose a desired page by a second click on a page number, which links the user to the catalog page corresponding to the page number clicked in field 72 shown in FIG. 4. Clicking on a desired catalog and then on a page number in field 72 corresponds to the step 37 in FIG. 2 of requesting a particular catalog page.

At step 38 of FIG. 2, web server 12 sends to a customer's computer 18 the low resolution image of the requested catalog page, such as catalog page “29” (web page 33) shown in FIG. 5, after which the customer's web browser 20 displays web page 33 on customer's computer 18.

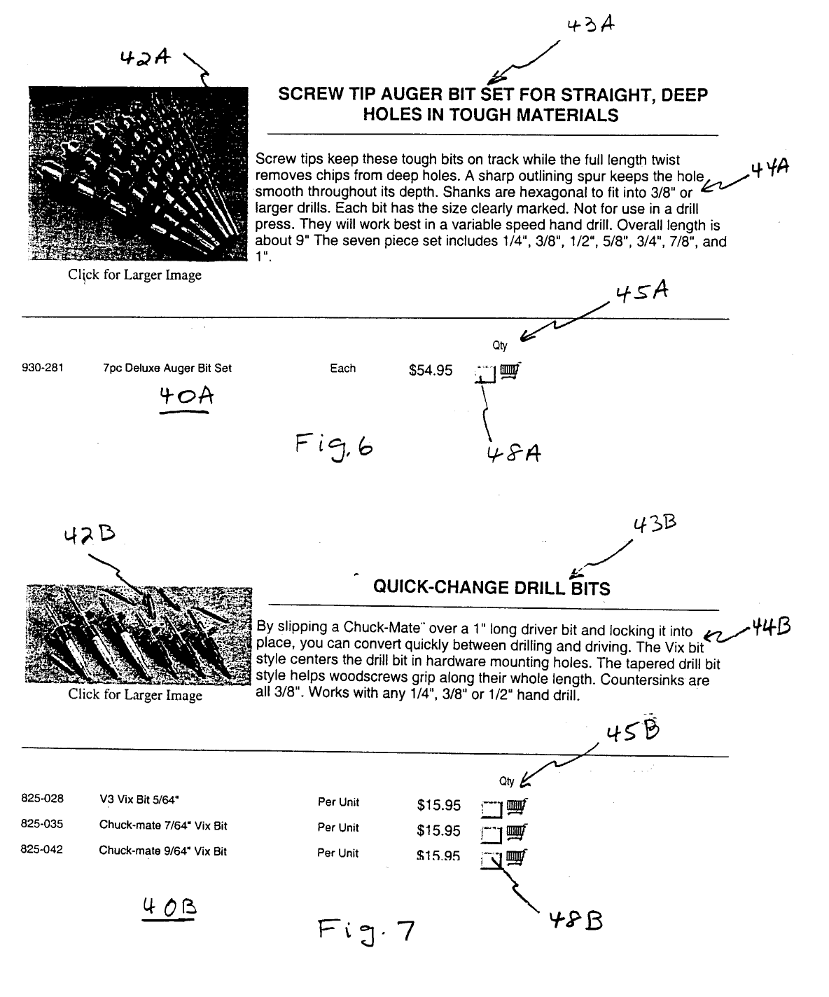

At step 39 of FIG. 2, the customer clicks in an outlined area for a given product, such as, by way of example, area 35 shown in FIG. 5. Clicking on outlined area 35 links the user to another web page 40 shown in FIG. 6 that is a detailed presentation of the product shown in area 35 of FIG. 5. This detailed presentation of such product is dynamically created at step 41 of FIG. 2. The web server 12 presents one of the pages 16 which is a detailed presentation of the product shown in the low resolution image of the web page 33 shown in FIG. 5.

Referring simultaneously to FIGS. 2 and 6, the detailed presentation 40A shown in FIG. 6 typically includes a high resolution photograph 42A, a headline 43A, product copy 44A and an order block 45A for purchasing the product pictured and described in FIG. 6. The high resolution photograph 42A is generated from a JPG file 42 accessed by web server 12. The headline 43A, copy 44A and order block 45A are all dynamically generated from headline file 43, copy file 44 and order block data file 45, respectively, also accessed by web server 12. At step 46 of FIG. 2, the presentation of FIG. 6 is sent through the Internet to browser 20, where it is displayed on the customer's system 18. After the detailed presentation 40A is displayed on the customer system 18, at step 47 of FIG. 2, the customer makes a buy decision as to whether to purchase the product presented on his or her system 18.

If the customer chooses to buy the product, he or she clicks a buy button 48A shown in FIG. 6, whereupon at step 49 of the flowchart of FIG. 2, the order is processed. If the customer chooses to not purchase the product, he or she simply clicks the back button on the web browser to return to the previously displayed low resolution image catalog page.

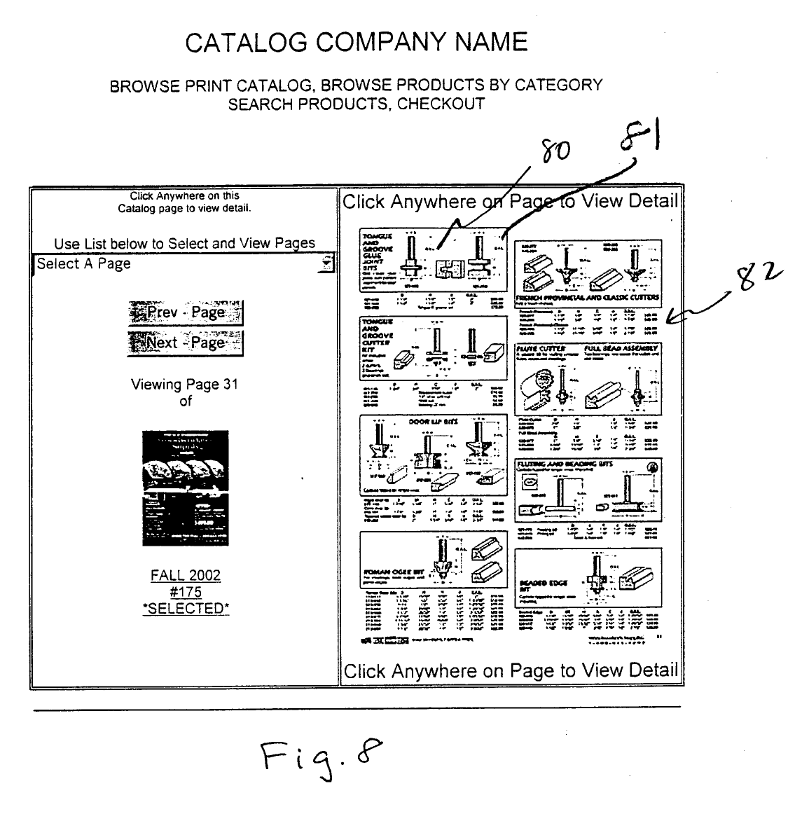

Referring again to FIG. 5, if a customer decides to purchase a different product 50 shown in the low resolution image catalog page “29” (web page 33), then he or she clicks in the outline area 50 for such product to obtain a detailed product presentation for that particular product. The new detailed presentation 40B shown in FIG. 7 is then accessed when link 50 in low resolution image web page 33 is clicked. Here again, the detailed presentation 40B shown in FIG. 7 includes a high resolution photograph 42B of the product, a headline 43B, product copy 44B and an order data block 45B. If the customer wishes to order the product shown in FIG. 7, he or she again clicks the buy button 48B to initiate the purchase.

Also included in the web page 70 (FIG. 4) for selecting particular catalog pages by page number, is a search link 73 which links the user to a field (not shown) in which can be typed a product name or product description keyword for purposes of locating the catalog page, or pages, on which such product is displayed and described. Once the product name or keyword is entered in the field, a “Go” button (not shown) is clicked, which then links the customer to the low resolution image catalog page on which the product is displayed and described. With the right product name or keyword, the customer would again be linked to the web page showing, for example, the low resolution image web page 33 (catalog page 29) of FIG. 5. If the customer then wanted additional information about any of the products shown in catalog page 29, he or she would again click an outline area, such as, for example, areas 35 or 50, to retrieve one or the other of the detailed product presentation 40A or 40B shown in FIGS. 6 and 7, respectively.

As noted above, at step 39 of FIG. 2, a customer can click in an outlined area for a given product shown in a low resolution image of a catalog page to obtain a detailed presentation of the product. As also noted above, the detailed presentation of the product is dynamically created at step 41 of FIG. 2, and includes a high resolution image, a headline, product copy, and an order block for purchasing the product. It should be noted that the step of creating a detailed presentation of a product can be a multiple step process in which an intermediate sized high resolution image is first presented with a hyperlink that allows a customer to click and thereby request yet a larger high resolution image that is easier for a customer to see than the intermediate image.

The detailed presentation can also include product specifications not shown in the low resolution image of the product. These product specifications can pertain to any aspect of a product, such as, for example, a product's size, shape, weight, color, materials, dimensions, etc. According to the method of the present invention, the product specifications are preferably displayed in a table format. Preferably, the table includes rows and columns and is “elastic” in that can be varied in size and format to display as much or as little information about a product that is likely to be of interest to the buying public. Thus, by way of example, such information could include a limited number of product dimensions, such as the length, width and height of a product, or a greater number of dimensions that would also include the angle, radius or diameter of particular parts or features of a product.

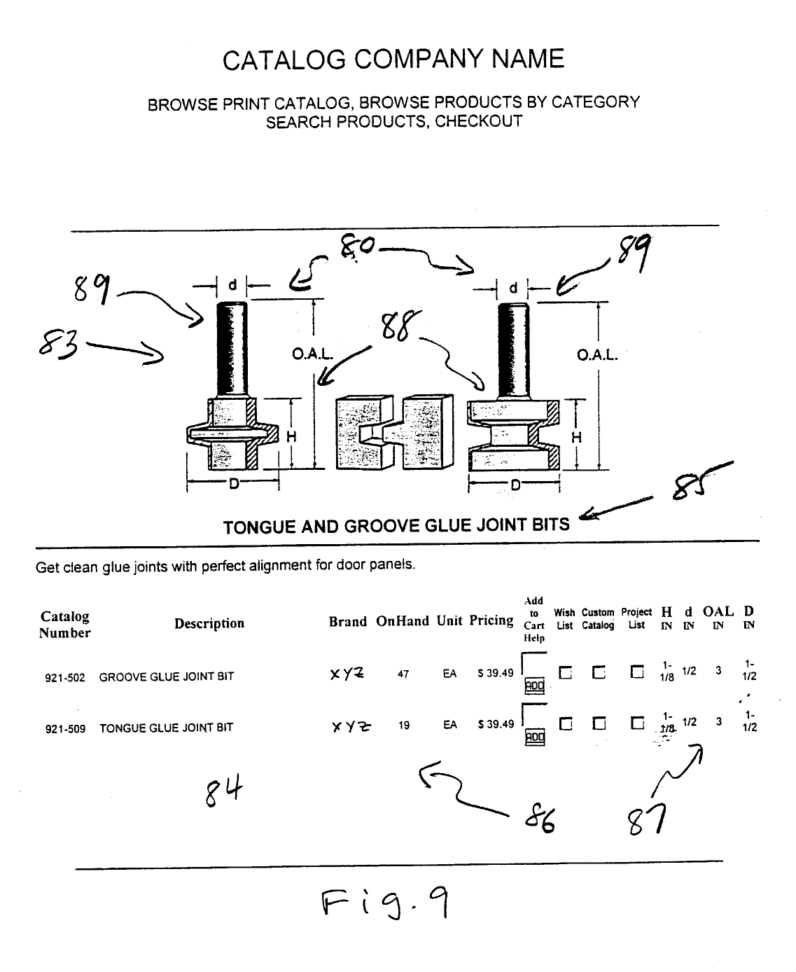

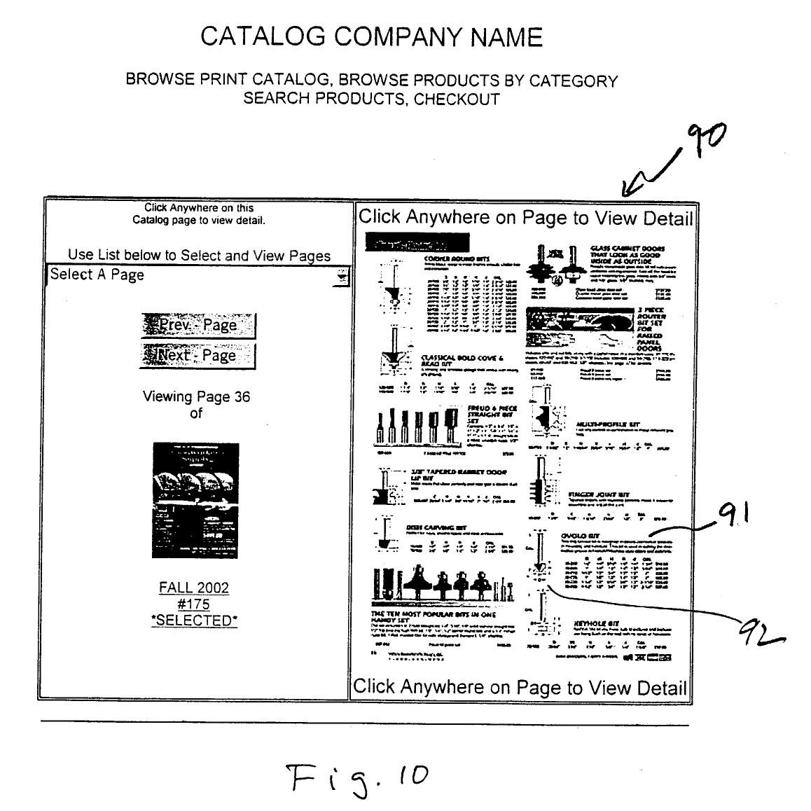

Referring now to FIG. 8, if a customer decides to purchase yet another product 80 shown in the low resolution image catalog page “31 ” (web page 82), then he or she clicks in the outline area 81 for product 80 to obtain a detailed product presentation for that particular product. The new detailed presentation 84 shown in FIG. 9 is then accessed when link 80 in low resolution image web page 82 is clicked. Here again, the detailed presentation 84 shown in FIG. 9 includes a high resolution image 83 of the product, a headline 85, and an order data block 86. The detailed presentation 84 can also include product copy (not shown in FIG. 9) and an extension of the order data block that is a table 87 showing various dimensions of the product 80. Table 87 in FIG. 9 includes the overall length “O.A.L.” of each joint bit 80 shown in FIG. 9, the height “H” and diameter “D” of the cutting portion 88 of each joint bit 80, and a smaller diameter “d” of a drive shaft 89 that is engaged by a router driving the joint bits 80.

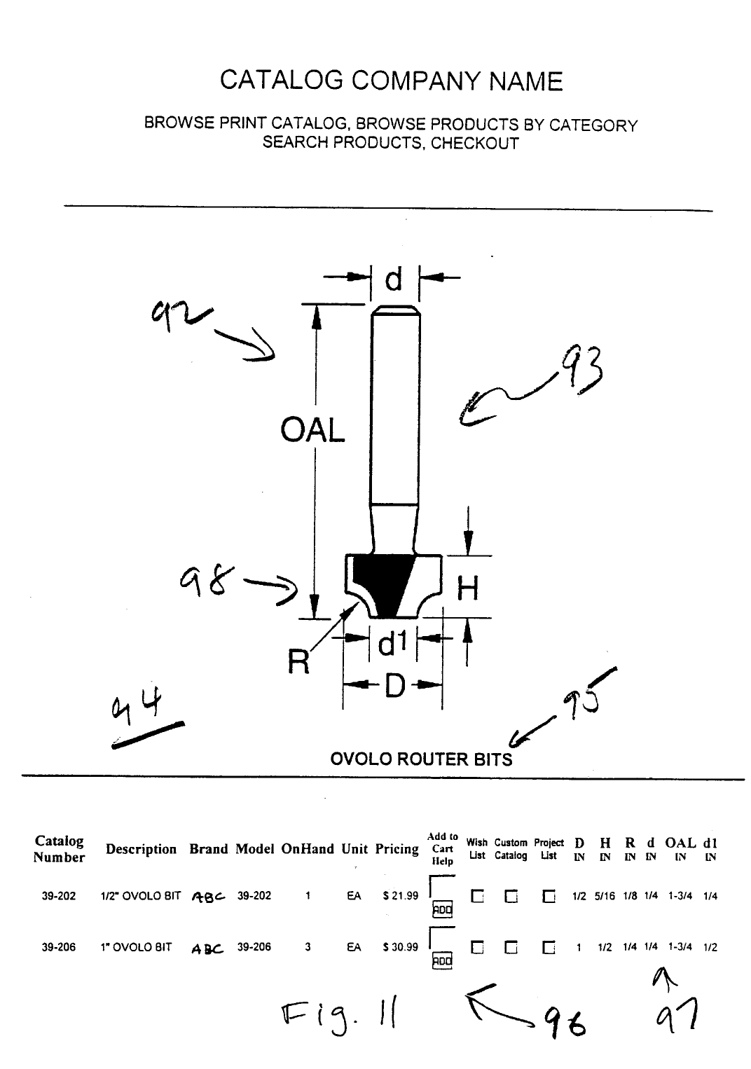

FIG. 10 shows the low resolution image of yet another catalog page “36” (web page 90), that includes yet another product 92 that a customer may decide to buy. To obtain a detailed product presentation for product 92, the customer again clicks in the outline area 91 for product 92. The new detailed presentation 94 shown in FIG. 11 is then accessed when link 91 in low resolution image web page 90 is clicked. The detailed presentation 94 shown in FIG. 11 includes a high resolution image 93 of product 92, a headline 95, and an order data block 96. Here again, the detailed presentation 94 does not include product copy, but it does include an extension of the order data block that is a table 97 showing various dimensions of the product 92. Table 97 in FIG. 11 includes the overall length “O.A.L.” of router bit 92, the height “H” and overall diameter “D” of the cutting portion 98. For cutting portion 98, table 97 also includes a smaller diameter “d1” of, and a radius “R” for, cutting portion 98. Table 97 further includes a smaller diameter “d” of a drive shaft 99 that is engaged by a router driving router bit 92.

Tables 87 of FIG. 9 and table 97 of FIG. 11 are each dynamically “built” in response to a request for a detailed product presentation. Web server computer 10 (FIG. 1) uses product specifications stored in the series of product files 19. When either link 81 corresponding to product 80 or link 91 corresponding to product 92 is clicked to obtain a detailed product presentation, web server 10 accesses product specifications for the selected product that are stored in files 19 located in web server 10 to build table 87 or table 97. The size and format of a product specification table will vary according to the type and amount of product specification data stored in files 19 corresponding to the selected product. The kind of variation that can occur in product specifications displayed can be seen by a comparison of the product specification data included in table 97 versus that included in table 87.

Preferably, the attributes included in the specification table consist of an attribute Name, an attribute Dimension and an attribute Value. Some examples of names that can be used with the present invention are simple letters (e.g., A, B, C, etc.) referring to dimensions on a drawing in the presentation. Other Names that can be used with the present invention are descriptive words such as “Width”, “Height” or “Weight”. Examples of Dimensions that can be used include “Inches”, “Centimeters” and “Pounds”. To insure that errors are not made, the Names and Dimensions for products are chosen from user-defined lists of “Allowable Names” and “Allowable Dimensions”. The Value is simply the corresponding value. Thus, by way of example, if a specification for a saw weighing 10 lbs. is added to the product data base, the “Name” would be “Weight”, the “Dimension” would be “Pounds” and the “Value” would be 10. One benefit provided by this system of specification is that a company's entire product web site can be readily changed from an English measurement system to a Metric measurement system (or other system of measures) programmatically using only a units conversion table. This feature eliminates the need to store the data on the product in different systems of measure.

Although the present invention has been described in terms of a particular embodiment, it is not intended that the invention be limited to that embodiment. Modifications of the disclosed embodiment within the spirit of the invention will be apparent to those skilled in the art. The scope of the present invention is defined by the claims that follow.

What is claimed is:

1. A method of displaying product information in a product catalog accessed via a telecommunications network comprising:
for each page of said product catalog, storing in a first device connected to said network a file containing a low resolution scan of said catalog page,
transmitting from a second device connected to said network at least one request for at least one page of said product catalog,
transmitting from said first device in response to said at least one page request said low resolution scan file of said requested catalog page,
for each product displayed on said low resolution scan of said requested catalog page, storing in said first device a plurality of files from which a detailed presentation of said product is prepared, wherein at least one of said products displayed on said low resolution scan of said requested catalog page has a corresponding detailed product presentation that includes at least one specification pertaining to said product,
transmitting from said second device at least one second request for one of said detailed product presentations, and
transmitting from said first device in response to said at least one second request said detailed product presentation file.

2. The method of claim 1 wherein at least one of said products displayed on said low resolution scan of said requested catalog page includes a marking to denote the existence of said at least one product specification in said detailed product presentation.

3. The method of claim 1 wherein the step of preparing the detailed product presentation file comprises obtaining information from:
a first file containing a high resolution image of said product,
a second file identifying said product,
a third file containing a description of said product,
an fourth file containing ordering information for purchasing said product, and
a fifth file containing said at least one specification for said product.

4. The method of claim 1 wherein the step of transmitting said detailed product presentation file comprises transmitting:
said high resolution image of said product,
said headline file identifying said product,
said description of said product,
said ordering information for purchasing said product, and
said at least one product specification.

5. The method of claim 1 wherein the step of transmitting said detailed product presentation includes transmitting at least one specification selected from the group consisting of product size, shape, weight, color, materials, and dimensions.

6. The method of claim 1 wherein the steps of transmitting said at least one request for at least one page of said product catalog and of transmitting said at least one second request for one of said detailed product presentations are performed by a browser program stored on said second device.

7. The method of claim 1 wherein the steps of transmitting said low resolution scan file of said requested catalog page and of transmitting said detailed product presentation file are performed by a server program stored on said first device.

8. A method of displaying product information in a product catalog accessed via the Internet comprising:
storing in a first device connected to the Internet a file corresponding to a web page for said product catalog,
for each page of said product catalog, storing in said first device a corresponding file containing a low resolution scan of said catalog page,
for each product displayed on each said low resolution scan of each said catalog page, storing in said first device a plurality of files from which a detailed presentation of said product is dynamically prepared, wherein at least one of said products displayed on said low resolution scan of said requested catalog page has a corresponding detailed product presentation that includes a plurality of specifications pertaining to said product,
transmitting from said second device a first at least one request for at least one page of said product catalog,
transmitting from said first device in response to said request for said at least one page said low resolution scan file of said requested catalog page,
transmitting from said second device a second at least one request for one of said detailed product presentations corresponding to at least one product displayed on said low resolution scan of said catalog page, and
transmitting from said first device in response to said at least one request said detailed product presentation file.

9. The method of claim 8, wherein at least one of said products displayed on said low resolution scan of said requested catalog page includes a marking to denote the existence of said plurality of product specifications in said detailed product presentation.

10. The method of claim 8 wherein the step of preparing said corresponding detailed product presentation comprises obtaining information from:
a first file containing a high resolution image of said product,
a second file identifying said product,
a third file containing a description of said product,
a fourth file containing ordering information for purchasing said product, and
a fifth file containing said plurality of specifications for said product.

11. The method of claim 8 wherein the step of transmitting said corresponding detailed product presentation file comprises transmitting:
said high resolution image of said product,
said headline file identifying said product,
said description of said product,
said ordering information for purchasing said product, and
said plurality of product specifications.

12. The method of claim 8 wherein the step of transmitting said detailed product presentation includes transmitting a plurality of specifications selected from the group consisting of product size, shape, weight, color, materials, and dimensions.

13. The method of claim 8 wherein the steps of transmitting said at least one request for at least one page of said product catalog and of transmitting said at least one second request for one of said detailed product presentations are performed by a browser program stored on said second device.

14. The method of claim 8 wherein the steps of transmitting said low resolution scan file of said requested catalog page and of transmitting said detailed product presentation file are performed by a server program stored on said first device.

15. A system for displaying product information in a product catalog accessed via a telecommunications network comprising:
means for storing in a first device connected to said network a file containing a low resolution scan for each page of said product catalog,
means for transmitting from a second device connected to said network at least one request for at least one page of said product catalog,
means for transmitting from said first device in response to said at least one page request said low resolution scan file of said requested catalog page,
means for storing in said first device a plurality of files from which is prepared a detailed presentation of each product displayed on said low resolution scan of said requested catalog page, wherein at least one of said products displayed on said low resolution scan has a corresponding detailed product presentation that includes at least one specification pertaining to said product,
means for transmitting from said second device at least one second request for one of said detailed product presentations, and
means for transmitting from said first device in response to said at least one second request said detailed product presentation file.

16. The system of claim 15 wherein at least one of said products displayed on said low resolution scan of said requested catalog page includes a marking to denote the existence of said at least one product specification in said detailed product presentation.

17. The system of claim 15 wherein said detailed product presentation is comprised of information from:
a file containing a high resolution image of said product,
a headline file identifying said product,
a copy file containing a description of said product,
an order block data file containing ordering information for purchasing said product, and
a data base containing said at least one specification for said product.

18. The system of claim 15 wherein said means for transmitting said detailed product presentation includes means for transmitting at least one specification selected from the group consisting of said product's size, shape, weight, color, materials, and dimensions.

19. A system for displaying product information in a product catalog accessed via the Internet comprising:
a first device connected to the Internet for storing, for each product page of said product catalog, a corresponding file containing a low resolution scan of such product page, and for each product displayed on said low resolution scan of said catalog page, a plurality of files from which is prepared a detailed product presentation for such product;
a second device connected to the Internet for use by a customer;
a first program stored in said second device for requesting and displaying information about products in said product catalog, said first program including at least one module for requesting and displaying: at least one access page for said product catalog, at least one page of said product catalog, and at least one detailed product presentation corresponding to at least one product displayed on said low resolution scan of said catalog page; and
a second program stored in said first device for transmitting descriptions of and ordering information about products in said product catalog, said second program including:
a first module for transmitting access pages for said product catalog,
a second module for transmitting in response to said request for at least one page of said product catalog a file containing a low resolution scan of said requested catalog page, and
a third module for transmitting in response to said at least one second request for said detailed product presentation a file containing a high resolution image of said product, a headline identifying said product, copy describing said product, and ordering information for purchasing said product,
wherein at least one of said products displayed on said low resolution scan has a corresponding detailed product presentation that includes a plurality of specifications pertaining to said product.

20. The system of claim 19 wherein at least one of said products displayed on said low resolution scan of said requested catalog page includes a marking to denote the existence of said at least one product specification in said detailed product presentation.

21. The system of claim 19 wherein said third module for transmitting said detailed product presentation includes a fourth module for transmitting at least one specification selected from the group consisting of said product's size, shape, weight, color, materials, and dimensions.

22. The system of claim 19 wherein said first program is a browser program.

23. The system of claim 22 wherein said first program further comprises at least one module for providing at said second device a plurality of displays with hyperlinks for initiating said requests for said web page for said product catalog, said at least one page of said product catalog, and said at least one detailed product presentation corresponding to said at least one product displayed on said low resolution scan of said catalog page.

24. The system of claim 19 wherein said second device is a personal computer.

25. The system of claim 19 wherein said second program is a server program.

26. The system of claim 19 wherein said first device is a server computer.

27. The method of claim 2 wherein the marking is a selected color used to color said at least one product displayed on said low resolution scan of said requested catalog page.

28. The method of claim 27 wherein the marking color is red.

29. The method of claim 2 wherein the marking color is yellow.

30. The method of claim 9 wherein the marking is a selected color used to color said at least one product displayed on said low resolution scan of said requested catalog page.

31. The method of claim 30 wherein the marking color is red.

32. The method of claim 30 wherein the marking color is yellow.

33. The system of claim 16 wherein the marking is a selected color used to color said at least one product displayed on said low resolution scan of said requested catalog page.

34. The system of claim 33 wherein the marking color is red.

35. The system of claim 33 wherein the marking color is yellow.

36. The system of claim 20 wherein the marking is a selected color used to color said at least one product displayed on said low resolution scan of said requested catalog page.

37. The system of claim 36 wherein the marking color is red.

38. The system of claim 36 wherein the marking color is yellow.

39. The method of claim 1 wherein the step of transmitting said detailed product presentation includes transmitting product specifications of overall length, height and width.

40. The method of claim 1 wherein the step of transmitting said detailed product presentation includes transmitting product specifications of radius, angle and diameter.

41. The method of claim 8 wherein the step of transmitting said detailed product presentation file includes transmitting product specifications of overall length, height and width.

42. The method of claim 8 wherein the step of transmitting said detailed product presentation includes transmitting product specifications of radius, angle and diameter.

43. The system of claim 15 wherein the means for transmitting said detailed product presentation file includes transmitting product specifications of overall length, height and width.

44. The method of claim 15 wherein the means for transmitting said detailed product presentation file includes transmitting product specifications of radius, angle and diameter.

45. The system of claim 19 wherein the third module further transmits product specifications of overall length, height and width.

46. The system of claim 19 wherein the third module further transmits product specifications of radius, angle and diameter.

47. The method of claim 1 wherein the step of transmitting said detailed product presentation comprises transmitting a table of product specifications.

40. The method of claim 1 wherein the step of transmitting said detailed product presentation includes transmitting product specifications of radius, angle and diameter.

41. The method of claim 8 wherein the step of transmitting said detailed product presentation file comprises transmitting a table of product specifications.

42. The method of claim 8 wherein the step of transmitting said detailed product presentation includes transmitting product specifications of radius, angle and diameter.

43. The system of claim 15 wherein the means for transmitting said detailed product presentation file comprises transmitting a table of product specifications.

44. The method of claim 15 wherein the means for transmitting said detailed product presentation file includes transmitting product specifications of radius, angle and diameter.

45. The system of claim 19 wherein the third module further transmits product specifications presented in the form of a table.

46. The system of claim 19 wherein the third module further transmits product specifications of radius, angle and diameter.

47. The method of claim 1 wherein the step of transmitting said detailed product presentation comprises transmitting a table of product specifications.

48. The method of claim 47 wherein the step of transmitting said table of product specifications comprises dynamically building the table so that the table can be enlarged or reduced to display all or a portion of information about the product that is stored in a file containing at least one specification for such product.

49. The method of claim 47 wherein the table of product specifications includes attributes comprising an attribute Name, an attribute Dimension and an attribute Value.

50. The method of claim 49 wherein the attribute Name is a letter referring to a product dimension or a word descriptive of the product dimension.

51. The method of claim 8 wherein the step of transmitting said detailed product presentation file comprises transmitting a table of product specifications.

52. The method of claim 50 wherein the step of transmitting said table of product specifications comprises dynamically building the table so that the table can be enlarged or reduced to display all or a portion of information about the product that is stored in a file containing at least one specification for such product.

53. The method of claim 51 wherein the table of product specifications includes attributes comprising an attribute Name, an attribute Dimension and an attribute Value.

54. The method of claim 53 wherein the attribute Name is a letter referring to a product dimension or a word descriptive of the product dimension.

55. The system of claim 15 wherein the means for transmitting said detailed product presentation file comprises transmitting a table of product specifications.

56. The method of claim 55 wherein the step of transmitting said table of product specifications comprises dynamically building the table so that the table can be enlarged or reduced to display all or a portion of information about the product that is stored in a file containing at least one specification for such product.

57. The method of claim 55 wherein the table of product specifications includes attributes comprising an attribute Name, an attribute Dimension and an attribute Value.

58. The method of claim 57 wherein the attribute Name is a letter referring to a product dimension or a word descriptive of the product dimension.

59. The system of claim 19 wherein the third module further transmits product specifications presented in the form of a table.

60. The system of claim 59 wherein the step of transmitting said table of product specifications comprises dynamically building the table so that the table can be enlarged or reduced to display all or a portion of information about the product that is stored in a file containing at least one specification for such product.

61. The method of claim 59 wherein the table of product specifications includes attributes comprising an attribute Name, an attribute Dimension and an attribute Value.

62. The method of claim 61 wherein the attribute Name is a letter referring to a product dimension or a word descriptive of the product dimension.

63. A method of displaying product information in a product catalog accessed via a telecommunications network comprising:
for each page of said product catalog, storing in a first device connected to said network a file containing a low resolution scan of said catalog page,
transmitting from said first device in response to at least one request for a page of said product catalog said low resolution scan file of said requested catalog page,
for each product displayed on said low resolution scan of said requested catalog page, storing in said first device a plurality of files from which a detailed presentation of said product is prepared, wherein at least one of said products displayed on said low resolution scan of said requested catalog page has a corresponding detailed product presentation that includes at least one specification pertaining to said product, and
transmitting from said first device in response to at least one second request for one of said detailed product presentations said detailed product presentation file.
